(19) United States
(12) Patent Application Publication
(10) Pub. No.: US 2025/0194611 A1
(43) Pub. Date: Jun. 19, 2025

(54) METHOD AND DEVICE FOR PROVIDING CASED PORTIONS OF PASTY FOOD MASS

(71) Applicant: VEMAG Maschinenbau GmbH, Verden (DE)

(72) Inventor: Manuel Otten, Kirchlinteln (DE)

(21) Appl. No.: 18/986,628

(22) Filed: Dec. 18, 2024

(30) Foreign Application Priority Data
Dec. 18, 2023 (DE) 102023135648.8

(51) Int. Cl. A22C 11/00; A22C 15/00

(52) U.S. Cl. CPC A22C 11/006; A22C 15/001

(57) ABSTRACT

A method and a device provide portions of pasty food mass provided in a casing, in particular small sausage portions. In the device, at least a drive of a suspension machine or a drive of a looper horn or a portioning belt drive of a portioning apparatus is controlled by a controller. The controller assures that a defined number of portions is transferred from the portioning apparatus to a first hook of the suspension machine by looper horn at the beginning of a production phase.

### CROSS-REFERENCE TO RELATED APPLICATION

This application claims priority to, German Patent Application No. 102023135648.8, filed Dec. 18, 2023. The above-mentioned patent application is incorporated herein by reference in its entirety.

### TECHNICAL FIELD

This application relates to a method for providing portions of pasty food mass provided in a casing, in particular small sausage portions. This application further relates to a device for providing portions of pasty food mass provided in a casing, in particular small sausage portions.

### BACKGROUND

Some methods and devices are provided in the prior art, for example, by the applicant VEMAG in the context of a production line for small sausages in the form of strings of sausages, wherein one small sausage of the string forms a portion. In this type of a small sausage production line, the pasty sausage meat is provided by a filling machine, filled into the casing made from natural or artificial sausage casing, and divided into individual small sausage portions by twisting. A portioning apparatus with portioning belts provides the small sausage portions forming a string of sausages in the desired lengths and weights, and further transports the same to a suspension machine, where the strings of sausages are grouped, transferred, and suspended in various suspension patterns. Thus, for example, a certain number of small sausages may be transferred to one hook (of multiple hooks) of the suspension machine, so that a loop of sausages hangs down from the hook. After the transfer of a complete string of sausages in the context of a production phase, this is then removed from the suspension machine, for example, using a smoke stick, and may then be further processed, for example, smoked, cooked, or the like.

For certain applications, as are known, for example, from EP Patent Application Publication No. 3 878 284 A1 or U.S. Pat. No. 5,921,857, the small sausages are transferred at a transfer point from the portioning apparatus to the suspension machine by a looper or looper horn. The looper horn is rotated by a drive unit and projects at an angle relative to the axis of rotation and has a hollow interior, through which the small sausages of the string of sausages are transported in the direction of the suspension machine. Thus, with the aid of the looper, the string of sausages may be transferred to hooks of the suspension machine, and the number of sausages, which is transferred to one hook, may thereby be varied by a variable control of the drive of the looper and also the drive of the portioning apparatus and/or the suspension machine.

Production using a line of this type is carried out in multiple production phases. After preparation of the line, production begins, the drives start up and a separate string of sausages with a plurality of small sausages is filled, twisted, portioned, and suspended. A production phase is, in this respect, defined in particular by a continuous casing made of a natural or artificial sausage casing having a certain length. If, in this respect, a string of sausages has been produced, the production phase is ended. After interruption and the provision of a new casing, the next production phase may begin. During a production phase, a substantially continuous filling, portioning, and suspension takes place at the suspension machine.

The beginning and the end of a production phase require particular attention when operating the device or the method in question. After corresponding filling and portioning, the string of sausages is transferred by the looper to the first hook of the respective production phase. In practice, it has been observed that often too many or too few small sausage portions are transferred to the first hook (of a production phase) of the suspension machine. If too many small sausages are transferred to the first hook, the twists, previously generated by the portioning apparatus at a twist point between two portions, may undesirably untwist again while they hang down from the hook. This is due to the fact that a certain reverse torque may act on the twist point due to the elasticity of the sausage casing. This type of (reverse twisting) untwisting disturbs the production process and may lead to interruptions of the production phase. If too few small sausages are transferred to the first hook, they may fall down from the first hook, particularly as, in the case of too few small sausages, the suspended string of sausages is not pulled sufficiently downward by the force of gravity. Thus, the small sausage portions may fall to the ground and become unusable. In this case as well, the production process, the respective production phase, is undesirably interrupted. Sometimes, line operators attempt to catch the first portions by hand, which, however, is associated with some risk and is not necessarily reliable.

Thus, it would be desirable to specify a method and a device for providing, in particular, small sausage portions in a casing, in which the described disadvantages may be largely avoided, and, in particular, a production phase, and thus the production, may be reliably started and continued.

### SUMMARY

The present application solves the problem with a method of the type listed at the outset, in that, by a controller, at least the drive of the suspension machine and/or the drive of the looper horn and/or a portioning belt drive of the portioning apparatus is/are controlled, such that a defined number of portions is transferred from the portioning apparatus to a first hook of the suspension machine by the looper horn at the beginning of a production phase.

The present application further solves the problem with a device of the type listed at the outset, in that the controller is designed and equipped such that at least the drive of the suspension machine and/or the drive of the looper horn and/or a portioning belt drive of the portioning apparatus is controlled by the controller, such that a defined number of portions is transferred from the portioning apparatus to a first hook of the suspension machine by the looper horn at the beginning of a production phase.

By correspondingly equipping the controller, it may be achieved, by the device or the method according to the invention, that the drives of the suspension machine and/or of the looper and/or of the portioning belt of the portioning apparatus are controlled in a targeted way such that a defined number of (small sausage) portions is transferred to a first hook at the beginning of a production phase. For this purpose, the controller is correspondingly equipped, in particular equipped and implemented on the software side, such that the desired, defined number of portions may be transferred to the first hook. It is thus achieved according to the invention that a precisely defined number of portions, i.e., neither too many nor too few portions, are transferred to the first hook. It may thus be achieved that sufficient portions with the necessary weight hang down from the first hook, so that no undesired untwisting takes place, and, in the case of too few hanging small sausages, it prevents them from falling down off of the first hook. As a result, the invention achieves that a production phase is carried out through the reliable transfer of a defined, desired portion to the first hook of a production phase, and thus, in this regard, no difficulties arise and the production phase may be reliably continued.

According to one preferred embodiment, the controller is designed and equipped such that the defined number of portions may be changed and set by intervention at the controller. By correspondingly equipping the controller, it may be assured that the respectively desired, defined number may be adapted to different production parameters, in particular to the length and/or the weight of the portions and/or to the respective number of the twists or the quality of the twisting points between the individual portions of the string, or other parameters. Due to a corresponding change, for example, a simple variation of one parameter, the controller may thus be correspondingly individually changed and set by an operator. The number is preferably set as a function of the weight of one portion or of multiple portions.

Furthermore, it is particularly preferred that the number is determined as a function of the path from the delivery pipe of a filling machine for providing the food mass up to the closest hook of the suspension machine relative to the looper horn. It has been shown that this path, from the product delivery outlet, i.e., from the delivery pipe of the filling machine, up to the hook throat, may be implemented and determined on the software side. The number of portions that are to be produced arises from this path, even before the looper begins its rotation. This time delay preferably enables the desired, set number of portions to be guided out from the outlet of the looper when the positioning of the looper is in a vertically upwards position, in order to suspend the desired, set number on the first hook. Accordingly, a certain number of portions results mathematically, as a function of the aforementioned path.

According to one refinement of the invention, as a function of the path and the number of portions which are produced in the portioning apparatus, the controller controls the drive of the looper horn in such a way that a certain number of portions is transferred from the looper horn to a hook of the suspension machine.

The controller is particularly preferably equipped such that the portioning apparatus produces a number of portions, connected by the casing, and transfers them to the looper horn such that the number of portions is held there, and the number of portions is transferred while the looper horn faces substantially downward in a vertical position, and that subsequently, the predetermined number of portions is then transferred from the looper horn to a hook by the looper horn, in particular to a first hook of a production phase, in order to suspend the defined number of portions at this hook.

The controller suitably has at least one processor, memory, software, an operating unit and a display, and the controller is equipped such that the parameter number of portions for a hook, in particular for a first hook, is input into the stored software of the controller by an operator by the operating unit or via an electric interface.

The described effects and advantages relate both to the method according to the invention and also to the device according to the invention. The device is advantageously further refined in that the portioning apparatus has two circulating portioning belts arranged spaced apart from one another and a portioning belt drive, and food mass, located in a casing, may be transferred from a filling machine, upstream of the portioning apparatus, through a delivery pipe to the portioning apparatus, and that the looper horn is arranged at the output area of the portioning apparatus in order to be able to transfer portions in a desired number per time unit and with a desired target weight to the looper horn, and that, on the outlet side downstream of the looper horn, the hooks of the suspension machine may be moved such that a desired number of portions may be transferred from the looper horn to the hooks of the suspension machine.

### BRIEF DESCRIPTION OF THE DRAWINGS

Further advantages, features, and possible applications of the present invention result from the following description in more detail in conjunction with the figures.

FIG. 1 is a schematic overview of a device according to the one embodiment for providing small sausage portions having a filling machine, portioning apparatus, and suspension machine in a schematic view from the side.

FIG. 2 is a top view in an enlarged depiction of parts of the filling machine, the portioning apparatus, a looper, and the suspension machine.

FIG. 3 is a top view in an enlarged depiction of parts of the filling machine, the portioning apparatus, a looper, and the suspension machine, with a path indicated from the end of the delivery pipe up to the hook throat.

FIG. 4 is a top view in an enlarged depiction of parts of the filling machine, the portioning apparatus, a looper, and the suspension machine.

FIG. 5 is a side view, in an enlarged depiction, of parts of the filling machine, the portioning apparatus, a looper, and the suspension machine.

FIG. 6 is a perspective view of parts of the filling machine, the portioning apparatus, the looper, and the suspension machine.

FIG. 7 is a schematic depiction of the control and drives of the components and for illustrating the method according to embodiments of the invention.

### DETAILED DESCRIPTION

Device 1 shown in the figures functions to provide portions made of a pasty food mass provided in a casing, here small sausage portions P in a string of sausages. Device 1 is designed to carry out a method, which is subsequently further described, and is part of a production line for producing small sausage portions P; however, other foodstuffs could also be processed into products.

A filling machine 2 with a conventional filling hopper for receiving pasty food mass, in this case sausage meat, has a pump and a controller (not shown) and a delivery pipe 46 for delivering the food mass into a casing. Downstream of filling machine 2 is a portioning apparatus 4, with which the filled casing may be twisted at twisting points in order to thus generate individual small sausage portions P at a defined length L and with a defined target weight G, which form a string of sausages. The length of position L is indicated in FIG. 3 by way of example.

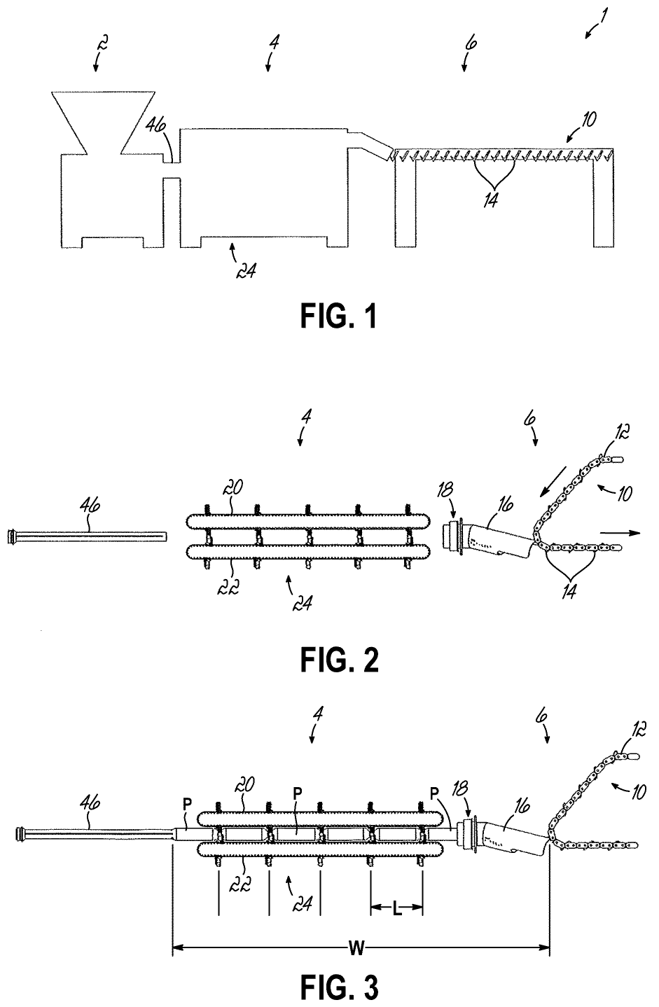

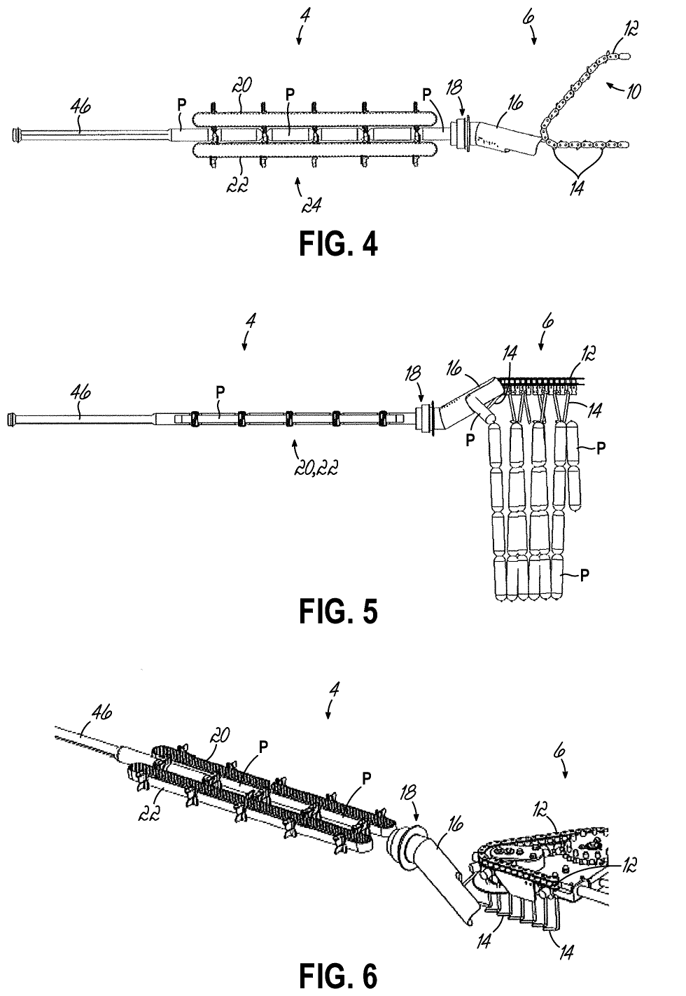

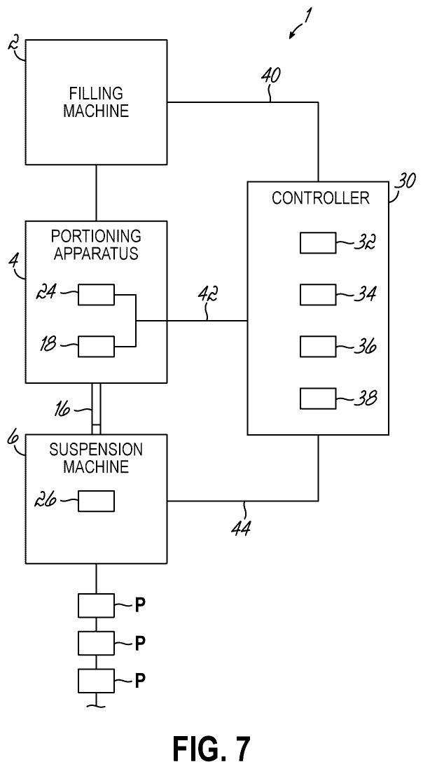

Portioning apparatus 4, as shown in FIGS. 2, 4, and 6, has two portioning belts 20, 22, arranged parallel to one another, and a portioning belt drive 24, which is shown schematically in FIGS. 1 and 7, as well as a looper horn 16 or looper 16 drivable by a drive 18, likewise shown in FIG. 7. Looper horn 16, projecting at an angle, moves with its open end section along a circular path to dispense portions P, and is designed in a known way to transfer multiple portions P connected to one another by the casing to a suspension machine 6.

Suspension machine 6, shown in FIGS. 1-6, for transporting multiple portions P, has a plurality of hooks 14 for receiving multiple portions P connected by the casing, in that a string of sausages is suspended at a twisting point in the throat of a hook 14. Hooks 14 are movable by at least one circulating drive element 10 drivable by a drive 26 (FIG. 7) in order to be able to transport the string of sausages. Drive element 10 is designed as a circulating chain, compare, in particular, FIGS. 2, 3, 4, 5, and 6. Portioning apparatus 4 in the example has two circulating portioning belts 20, 22 arranged spaced apart from one another and a portioning belt drive 24, compare FIGS. 1, 2, 7.

As shown in FIGS. 1-6, during operation, food mass is conveyed from filling machine 2, upstream of portioning apparatus 4, through delivery pipe 46 and transferred to portioning apparatus 4. There, a twisting, and thus a portioning into individual portions P, which form a string of sausages, is carried out by a twist off unit, known to experts in the art and not shown here. Rotatable, hollow looper horn 16 is arranged at the output area of portioning apparatus 4, by which looper horn portions P may be transferred in a desired length L, number per time unit (portion number per time unit), and with a desired target weight G to suspension machine 6. For this purpose, portioning apparatus 4, looper horn 16 and the suspension machine are arranged relative to one another such that, on the outlet side downstream of looper horn 16, hooks 14 of suspension machine 6 may be moved such that a desired number N of portions P may be transferred from looper horn 16 to hook 14 of suspension machine 6.

FIG. 7 schematically illustrates an electric controller 30 for controlling components of device 1 by a block diagram. Controller 30 has at least one processor 32, memory 34, an operating unit 36, and a display 38, as well as software which may process incoming signals, operator inputs, and may transmit control signals to the drives of the components.

Controller 30 is designed and equipped with regards to hardware and software such that at least one drive 8 of suspension machine 6 and/or drive 18 of looper horn 16 and/or a portioning belt drive 24 or, if necessary, 2 related drives 24 of portioning apparatus 4 may be controlled by controller 30 such that a defined number N of portions P is transferred from portioning apparatus 4 to a first hook 14 of suspension machine 6 by looper horn 16 at the beginning of a production phase. Controller 30 is further equipped such that parameter number N of portions P for a hook 14, in particular first hook 14, may be input into the stored software of controller 30 by an operator by operating unit 36 or via an electric interface.

During operation of the device, the following method is carried out:

Portions P are provided by portioning apparatus 4 having portioning belts 20, 22. Portions P, connected in a string of sausages, are transferred by looper horn 16 to hooks 14 of suspension machine 6. By controller 30, at least drive 8 of suspension machine 6 and/or drive 18 of looper horn 16 and/or a portioning belt drive 24 of portioning apparatus 4 is controlled, such that a variable, defined number N of portions P is transferred from portioning apparatus 4 to a first hook 14 of suspension machine 6 by looper horn 16 at the beginning of a production phase. Controller 30 is equipped such that defined number N of portions P may be changed and set by intervention at controller 30. It is possible that number N is set as a function of weight G of one portion P or of multiple portions P.

As FIG. 3 illustrates, number N is determined as a function of path W from delivery pipe 46 of filling machine 2 up to closest hook 14 of suspension machine 6 relative to looper horn 16. A certain number of portions P is calculated as a function of aforementioned path W. The number of portions P equals path W divided by the length of sausages L (P=W/L).

As a function of path W and the number of portions P, which are produced in portioning apparatus 4, controller 30 controls the drive of looper horn 16 in such a way that a certain number of portions P is transferred from looper horn 16 to a hook 14 of suspension machine 6.

In particular, the method is carried out and controller 30 is equipped such that portioning apparatus 4 produces a number of portions P connected by the casing, and transfers them to looper horn 16 such that the number of portions P is held there, and the number of portions P is transferred while looper horn 16 faces substantially downward in a vertical position. Subsequently, predetermined number N of portions P is then transferred from looper horn 16 to a hook 14 by looper horn 16, in particular to a first hook 14 of a production phase, in order to suspend defined number N of portions P at this hook 14. After the transfer of portions P, hooks 14 are further transported by suspension machine 4. Parameter number N of portions P for a hook 14, in particular first hook 14, is input as required into controller 30 by an operator by operating unit 36 or via an electric interface. Controller 30 further processes the input data and correspondingly controls the drives. Variations of the procedure are easily possible.

The embodiments described above are only descriptions of preferred embodiments of the present invention, and are not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. A method for providing portions of pasty food mass in a casing, the method comprising:
a) portions of pasty food mass located in a casing are provided by a portioning apparatus having portioning belts, the portioning apparatus having a portioning belt drive and a looper horn drivable by a drive,
b) the portions are transferred to hooks of a suspension machine by the looper horn of the portioning apparatus,
c) after the transfer of the portions, the hooks are further transported, and
d) by a controller, at least one of: the drive of the suspension machine, the drive of the looper horn, and a portioning belt drive of the portioning apparatus are controlled, such that a defined number of portions is transferred from the portioning apparatus to a first hook of the suspension machine by looper horn at the beginning of a production phase.

2. The method of claim 1, wherein the controller is designed and equipped such that the defined number of portions can be changed and set by intervention at the controller.

3. The method of claim 1, wherein the number is set as a function of the weight of one portion or of multiple portions.

4. The method of claim 1, wherein the number is determined as a function of a path from a delivery pipe of a filling machine for providing the food mass up to the closest hook of the suspension machine relative to the looper horn.

5. The method of claim 4, wherein a certain number of portions results mathematically as a function of the path.

6. The method of claim 4, wherein, as a function of the path and the number of portions which are produced in the portioning apparatus, the controller controls the drive of the looper horn in such a way that a certain number of portions is transferred from the looper horn to a hook of the suspension machine.

7. The method of claim 1, wherein the controller is equipped such that:
the portioning apparatus produces a number of portions connected by the casing, and transfers them to the looper horn such that the number of portions is held there, and the number of portions is transferred while the looper horn faces substantially downward in a vertical position,
and that subsequently, the predetermined number of portions is then transferred from the looper horn to a first hook by the looper horn, to suspend the defined number of portions at the first hook.

8. The method of claim 1, wherein the controller has at least one processor, memory, software, an operating unit and a display, and that the controller is equipped such that the parameter number of portions for the first hook is input into the stored software of the controller by an operator by the operating unit or via an electric interface.

9. A device for providing portions of pasty food mass in a casing, which is configured to carry out the method of claim 1, the device comprising:
a) a portioning apparatus for providing portions of pasty food mass located in a casing, which has portioning belts and a portioning belt drive, and a looper horn, drivable by a drive, which is designed to transfer multiple portions, connected to one another by the casing, to a suspension machine,
b) the suspension machine for transporting multiple portions, which has multiple hooks for receiving multiple portions connected by the casing, wherein the hooks may be further transported by at least one circulating drive element drivable by a drive, and
c) a controller for controlling components of the device,
wherein the controller is designed and equipped such that, at least one of: the drive of the suspension machine, the drive of the looper horn, and a portioning belt drive of the portioning apparatus are controlled, such that a defined number of portions is transferred from the portioning apparatus to a first hook of the suspension machine by looper horn at the beginning of a production phase.

10. The device of claim 9, wherein the controller has at least one processor, memory, an operating unit and a display, and that the controller is equipped such that the parameter number of portions for a first hook can be input into the stored software of the controller by an operator by the operating unit or via an electric interface.

11. The device of claim 9, wherein the portioning apparatus has two circulating portioning belts arranged spaced apart from one another and a portioning belt drive, and food mass, located in a casing, may be transferred from a filling machine, upstream of the portioning apparatus, through delivery pipe to the portioning apparatus, and that the looper horn is arranged at the output area of the portioning apparatus, to be able to transfer portions in a desired number per time unit and with a desired target weight to the looper horn, and wherein, on the outlet side downstream of the looper horn, the hooks of the suspension machine can be moved such that a desired number of portions can be transferred from the looper horn to the hooks of the suspension machine.
